(19) United States
(12) Patent Application Publication
(10) Pub. No.: US 2015/0003449 A1
(43) Pub. Date: Jan. 1, 2015

(54) PATH MAXIMUM TRANSMISSION UNIT LEARNING

(71) Applicant: Hangzhou H3C Technologies Co., Ltd., Hangzhou Zhejiang (CN)

(72) Inventor: Xiaohui Cui, Beijing (CN)

(21) Appl. No.: 14/372,736

(22) PCT Filed: Feb. 1, 2013
(86) PCT No.: PCT/CN2013/071261

§ 371 Date: Jul. 16, 2014

(30) Foreign Application Priority Data
Feb. 15, 2012 (CN) 201210033425.3

(51) Int. Cl. H04L 12/935; H04L 12/861

(52) U.S. Cl. CPC H04L 49/3072; H04L 49/9057
USPC 370/389

(57) ABSTRACT

According to an example, in a TCP connection establishment process, a forwarding equipment modifies a value of an MSS option in a Syn message so that the value of the MSS option in the Syn message is eventually modified to be equal to the smallest MTU value of all forwarding equipments in the TCP transmission path. The final value of the MSS option in the Syn message is also carried in the Syn+Ack message and the Ack message. A communication equipment can use the value of the MSS option to learn PMTU in the TCP connection establishment process.

### BACKGROUND

In Transmission Control Protocol (TCP) transmission of Internet Protocol version 6 (Ipv6), after a TCP connection has been established between two communication equipments such as a PC and a server, the two communication equipments can use the TCP connection to communicate messages. A forwarding equipment such as router between the two communication equipments is typically used to forward communication messages in a network between the communication equipments.

If the size of a communication message exceeds a Maximum Transmission Unit (MTU) value of an outport of the forwarding equipment, the communication message is typically discarded by the forwarding device and thus is not forwarded to its destination by the forwarding device. The forwarding device replies with an Internet Control Message Protocol (ICMP) packet oversized message to the source communication equipment of the communication message. The ICMP packet oversized message carries the MTU value of the outport of the forwarding equipment, so that the source communication equipment can fragment the communication message into pieces with a size smaller than the MTU value.

### BRIEF DESCRIPTION OF THE DRAWINGS

Features of the present disclosure are illustrated by way of example and not limited in the following figure(s), in which like numerals indicate like elements, in which:

FIGS. 1a-c are schematic diagrams of PMTU learning process implemented in an establishment of a TCP connection according to the present disclosure;

FIG. 2 is a flow chart of a PMTU learning method according to the present disclosure;

FIGS. 3a-c are schematic diagrams of another PMTU learning process implemented in an establishment of a TCP connection according to the present disclosure;

FIG. 4 is another flow chart of a PMTU learning method according to the present disclosure;

FIG. 5 is a hardware framework diagram of a PMTU learning apparatus according to the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

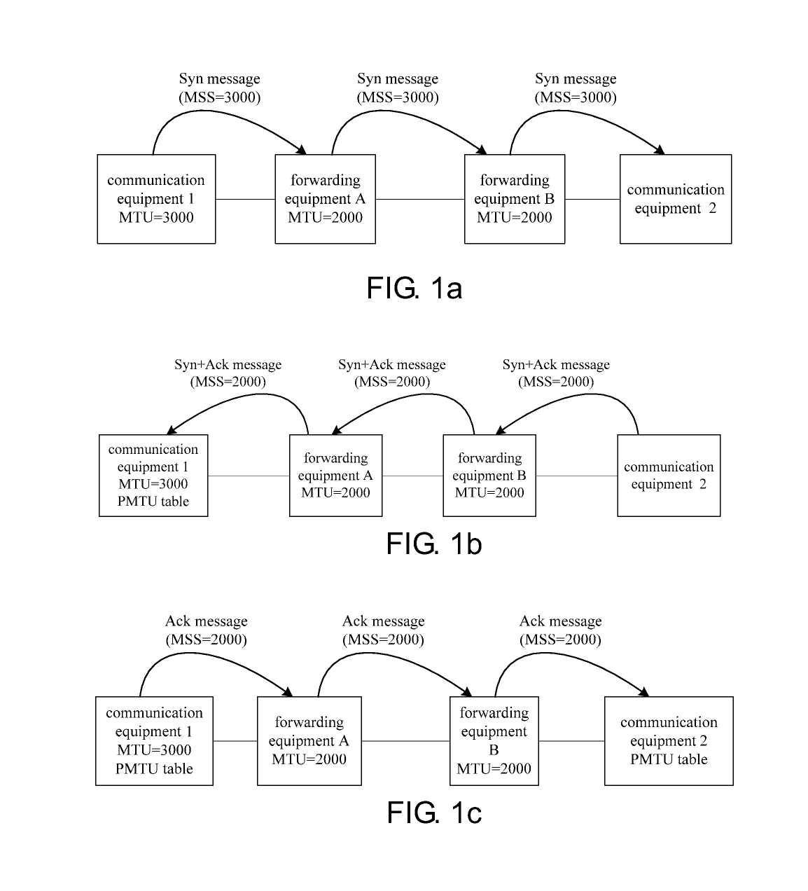

FIGS. 1a-1c are schematic diagrams of PMTU learning process implemented in an establishment of a TCP connection according to an example of the present disclosure. In FIGS. 1a-1c, as an example, there are forwarding equipments A and B between a communication equipment 1 and a communication equipment 2 desiring to establish a TCP connection with the communication equipment 1.

First, a first handshake process shown in FIG. 1a is discussed.

The communication equipment 1 sends a Syn message to the communication equipment 2; when the Syn message is sent from the communication equipment 1, a value of an MSS option in the Syn message is an MTU value 3000 of the communication equipment 1.

The forwarding equipment A receives the Syn message sent from the communication equipment 1 to the communication equipment 2, and determines that the value 3000 of the MSS option in the Syn message is greater than an MTU value 2000 of the local forwarding equipment A, and thus the forwarding equipment A first modifies the value of the MSS option in the Syn message with the MTU value 2000 of the local forwarding equipment A and then continues to forward the Syn message to the communication equipment 2.

The forwarding equipment B receives the Syn message sent from the communication equipment 1 to the communication equipment 2, and determines that the value 2000 of the MSS option in the Syn message is not greater than an MTU value 2000 of the local forwarding equipment B, and thus the forwarding equipment B does not modify the value 2000 of the MSS option in the Syn message and continues to forward the Syn message to the communication equipment 2.

After the communication equipment 2 receives the Syn message, the communication equipment 2 can identify the value 2000 of the MSS option in the Syn message.

Second, a second handshake process shown in FIG. 1b is discussed.

The communication equipment 2 replies with a Syn+Ack message to the communication equipment 1; when the Syn+Ack message is sent from the communication equipment 2, a value of an MSS option in the Syn+Ack message is the value 2000 of the MSS option in the Syn message when the Syn message reaches the communication equipment 2, i.e., it is the value 2000 of the MSS option which is identified by the communication equipment 2 from the Syn message.

The forwarding equipment B and the forwarding equipment A in turn forwards the received Syn+Ack message in which a value of the MSS option is 2000 to the communication equipment 1.

After the communication equipment 1 receives the Syn+Ack message, the communication equipment 1 confirms that a TCP connection is successfully established, learns the value 2000 of the MSS option in the Syn+Ack message as a PMTU of a TCP transmission path and a correct PMTU table can be established at one time.

Second, a third handshake process shown in FIG. 1c is discussed.

The communication equipment 1 replies with an Ack message to the communication equipment 2; when the Ack message is sent from the communication equipment 1, a value of an MSS option in the Ack message is the value 2000 of the MSS option in the Syn+Ack message when the Syn+Ack message reaches the communication equipment 1, i.e., it is the value 2000 of the MSS option which is identified by the communication equipment 1 from the Syn+Ack message.

The forwarding equipment A and the forwarding equipment B in turn forwards the received Ack message in which a value of the MSS option is 2000 to the communication equipment 2.

After the communication equipment 2 receives the Ack message, the communication equipment 2 confirms that the TCP connection is successfully established, learns the value 2000 of the MSS option in the Ack message as a PMTU of the TCP transmission path and a correct PMTU table can be established at one time.

In this way, based on the learned PMTU, both of the communication equipment 1 and the communication equipment 2 do not send a communication message with a length greater than 2000 bytes in following communications.

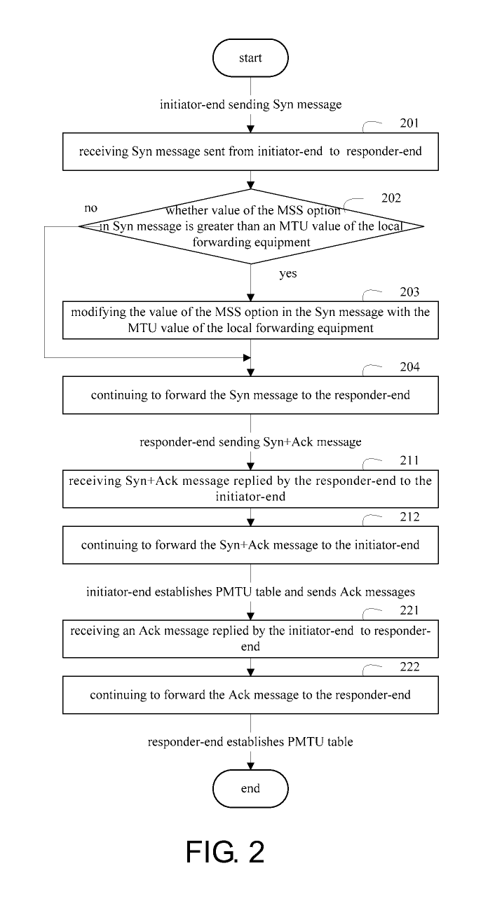

FIG. 2 is a flow chart of a PMTU learning method according to an example of the present disclosure. As shown in FIG. 2, based on the basic principle of the process shown in FIGS. 1a-1b, the PMTU learning method may include the following blocks performed in each forwarding equipment.

At block 201 a Syn message sent from an initiator-end communication equipment of a TCP connection to a responder-end communication equipment is received; when the received Syn message is sent from the initiator-end communication equipment, a value of an MSS option in the Syn message is an MTU value of the initiator-end communication equipment.

At block 202 a determination is made as to whether the value of the MSS option in the received Syn message is greater than an MTU value of the local forwarding equipment; if yes, block 203 is performed; otherwise, block 202 is performed.

At block 203 the value of the MSS option in the received Syn message is modified with the MTU value of the local forwarding equipment.

At block 204 the Syn message is continued to be forwarded to the responder-end communication equipment.

At block 211 a Syn+Ack message reply from the responder-end communication equipment is sent to the initiator-end communication equipment; when the Syn+Ack message is sent from the responder-end communication equipment, a value of an MSS option in the Syn+Ack message is the value of the MSS option in the Syn message when the Syn message reaches the responder-end communication equipment.

At block 212 the Syn+Ack message is continued to be forwarded to the initiator-end communication equipment.

After this block, the initiator-end communication equipment can learn the value (the smallest MTU value in the TCP transmission path) of the MSS option in the Syn+Ack message as a PMTU of the TCP transmission path and establishes a correct PMTU table, which for example includes storing the MTU value for the path in the PMTU table.

At block 221, an Ack message reply from the initiator-end communication equipment to the responder-end communication equipment is received; when the Ack message is sent from the initiator-end communication equipment, a value of an MSS option in the Ack message is the value (the smallest MTU value in the TCP transmission path which is learned as the PMTU) of the MSS option in the Syn+Ack message when the Syn+Ack message reaches the initiator-end communication equipment.

At block 222, the Ack message is continued to be forwarded to the responder-end communication equipment.

After this block, the responder-end communication equipment can learn the value (the smallest MTU value in the TCP transmission path) of the MSS option in the Ack message as a PMTU of the TCP transmission path and establishes a correct PMTU table.

At this point, the flow ends, and the initiator-end communication equipment and the responder-end communication equipment can start to exchange communication messages via the TCP path.

In addition to using the forwarding equipment to modify the value of the MSS option in the Syn message, other improvements may be made. For example, in the second handshake process that the responder-end communication equipment replies with the Syn+Ack to the initiator-end communication equipment, each forwarding equipment receives and forwards the Syn+Ack message. If one forwarding equipment determines that the value of the MSS option in the Syn+Ack message is greater than the MTU value of local forwarding equipment, it shows that the smallest MTU value in the TCP transmission path is changed, and the value of the MSS option in the Syn+Ack message is not the changed smallest MTU value in the TCP transmission path. Thus the forwarding equipment modifies the value of the MSS option in the Syn+Ack message with the MTU of the local forwarding equipment before forwarding the Syn+Ack message.

In this way, even if the MTU value of one or more forwarding equipments in the TCP transport path is changed which results in that the smallest MTU value in the TCP transport path is changed, after hop-by-hop comparison of all the forwarding equipments, the value of the MSS option in the Syn+Ack message eventually takes the changed smallest MTU value of all the forwarding equipments, i.e., the Syn+Ack message has a function of checking the smallest MTU value in the TCP transmission path. Further, the value of the MSS option in the ACK message of the third handshake can also be set to be equal to a final value of the MSS option in the Syn+Ack message which is equal to the smallest MTU value, so that the communication equipments at two ends can learn the PMTU through the three handshakes and PMTU learning caused by the changing in the MTU value of one or more forwarding equipments after the first handshake can be avoided.

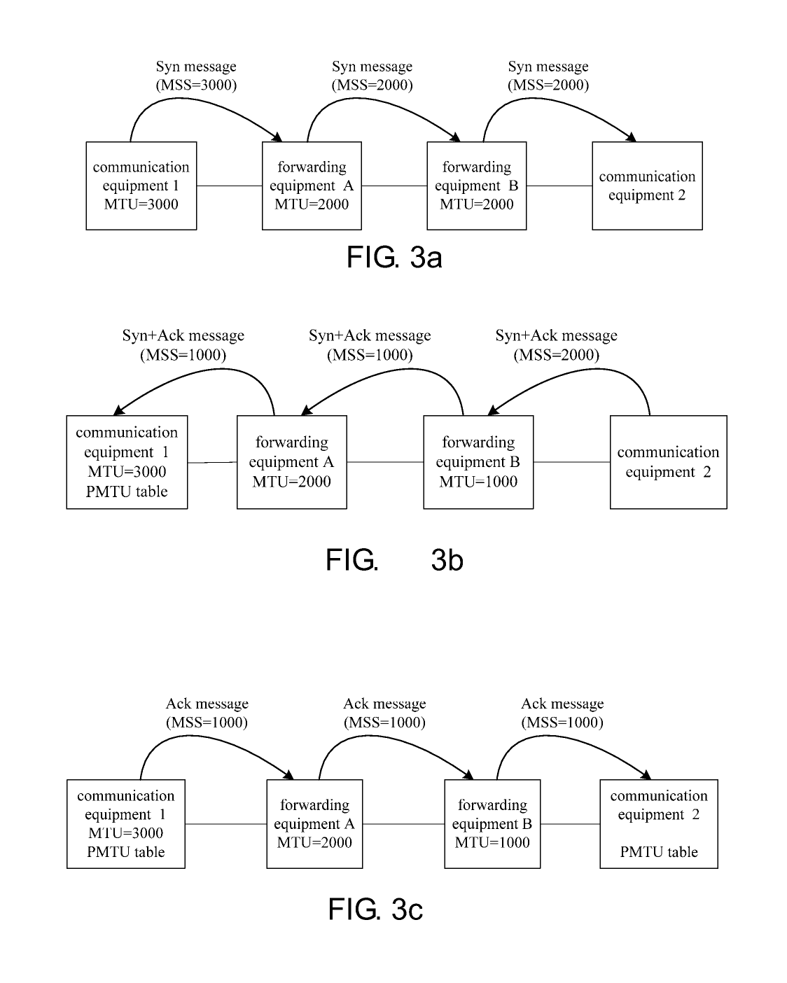

FIGS. 3a-3c are schematic diagrams of PMTU learning process implemented in an establishment of a TCP connection according to an example of the present disclosure. In FIGS. 3a-3c, as an example, there are forwarding equipments A and B between a communication equipment 1 and a communication equipment 2 desiring to establish a TCP connection with the communication equipment 1.

A first handshake process shown in FIG. 3a is the same as the first handshake process shown in FIG. 1a and thus is not repeated here.

A second handshake process shown in FIG. 3b is discussed.

The communication equipment 2 replies with a Syn+Ack message to the communication equipment 1; when the Syn+Ack message is sent from the communication equipment 2, a value of an MSS option in the Syn+Ack message is the value 2000 of the MSS option in the Syn message when the Syn message reaches the communication equipment 2, i.e., it is the value 2000 of the MSS option which is identified by the communication equipment 2 from the Syn message.

The forwarding equipment B receives the Syn+Ack message reply from the communication equipment 2 to the communication equipment 1; since the MTU value of the forwarding equipment B has changed to be 1000 after forwarding the Syn message of the first handshake, thus, the forwarding equipment B determines that the value 200 of the MSS option in the Syn+Ack message is greater than the changed MTU value 1000 of the local forwarding equipment B, thus the forwarding equipment B first modifies the value of the MSS option in the Syn+Ack message with the MTU value 1000 of the local forwarding equipment B and then continues to forward the Syn+Ack message to the communication equipment 1.

The forwarding equipment A receives the Syn+Ack message sent from the communication equipment 2 to the communication equipment 1, and determines that the value 1000 of the MSS option in the Syn+Ack message is not greater than an MTU value 2000 of the local forwarding equipment A, and thus the forwarding equipment A does not modify the value 1000 of the MSS option in the Syn+Ack message and continues to forward the Syn+Ack message to the communication equipment 1.

After the communication equipment 1 receives the Syn+Ack message, the communication equipment 1 confirms that a TCP connection is successfully established, learns the value 1000 of the MSS option in the Syn+Ack message as a PMTU of a TCP transmission path and a correct PMTU table can be established at one time.

A third handshake process shown in FIG. 3c is discussed.

The communication equipment 1 replies with an Ack message to the communication equipment 2; when the Ack message is sent from the communication equipment 1, a value of an MSS option in the Ack message is the value 1000 of the MSS option in the Syn+Ack message when the Syn+Ack message reaches the communication equipment 1, i.e., it is the value 1000 of the MSS option which is learned as PMTU by the communication equipment 1 from the Syn+Ack message.

The forwarding equipment A and the forwarding equipment B in turn forwards the received Ack message in which a value of the MSS option is 1000 to the communication equipment 2.

After the communication equipment 2 receives the Ack message, the communication equipment 2 confirms that the TCP connection is successfully established, learns the value 1000 of the MSS option in the Ack message as a PMTU of the TCP transmission path and a correct PMTU table can be established at one time.

In this way, based on the learned PMTU, both of the communication equipment 1 and the communication equipment 2 does not send a communication message with a length greater than 1000 bytes in following communication process.

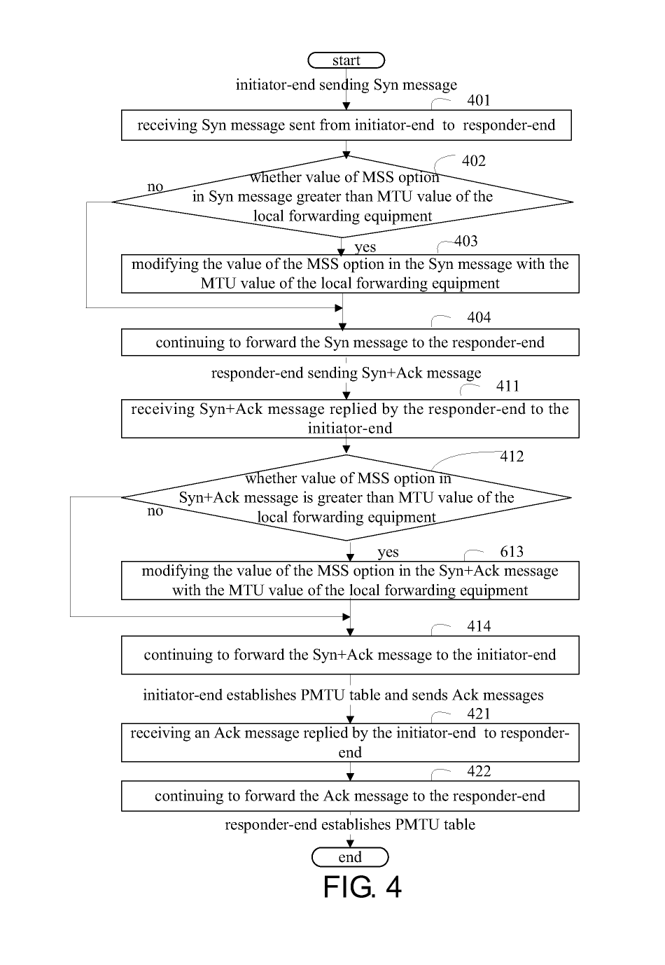

FIG. 4 is a flow chart of a PMTU learning method according to an example of the present disclosure. As shown in FIG. 4, based on the basic principle of the process shown in FIGS. 3a-3b, the PMTU learning method according to an example may be performed in each forwarding equipment.

Block 401-block 404 are the same as the blocks 201-block 204 shown in FIG. 2 and their description is not repeated here.

At block 411 a Syn+Ack message reply which is sent from the responder-end communication equipment to the initiator-end communication equipment is received; when the Syn+Ack message is sent from the responder-end communication equipment, a value of an MSS option in the Syn+Ack message is the value of the MSS option in the Syn message when the Syn message reaches the responder-end communication equipment.

At block 412, a determination is made as to whether the value of the MSS option in the received Syn+Ack message is greater than an MTU value of the local forwarding equipment; if yes, jumping to block 413; otherwise, jumping to block 414.

At block 413, the value of the MSS option in the received Syn+Ack message is modified with the MTU value of the local forwarding equipment.

At block 414, the Syn+Ack message is continued to be forwarded to the responder-end communication equipment.

After this block, the initiator-end communication equipment can learn the value (i.e., the changed smallest MTU value in the TCP transmission path) of the MSS option in the Syn+Ack message as a PMTU of the TCP transmission path and establishes a correct PMTU table.

Block 421-block 422 are the same as the block 221-block 222 shown in FIG. 2.

At this point, the flow ends, and the initiator-end communication equipment and the responder-end communication equipment can start to exchange communication messages.

It should be noted, after the initiator-end communication equipment receives the Syn+Ack message (i.e., confirming that the TCP connection is successfully established), the initiator-end communication equipment learns PMTU and establishes the PMTU table; after the responder-end communication equipment receives the Ack message (i.e., confirming that the TCP connection is successfully established), the responder-end communication equipment learns the PMTU and establishes the PMTU table; this makes the established PMTU table have higher security. However, the initiator-end communication equipment can establish a PMTU table according to the MTU of the initiator-end communication equipment before the TCP connection is successfully established, and can re-learn PMTU and update the PMTU table after the initiator-end communication equipment receives the Syn+Ack message (i.e., confirming that the TCP connection is successfully established); the responder-end communication equipment can also establish a PMTU table according to the MTU of the responder-end communication equipment before the TCP connection is successfully established, and can re-learn PMTU and update the PMTU table after the responder-end communication equipment receives the Ack message (i.e., confirming that the TCP connection is successfully established).

In addition to learning the PMTU in the TCP connection establishment process, the forwarding equipment can further determine whether the value of the MSS option in the Ack message is greater than the MTU value of the local forwarding equipment and determine whether the value of the MSS option in the communication message is greater than the MTU value of the local forwarding equipment. If it is determined that the value of the MSS option in the Ack message or the communication message is greater than the MTU value of the local forwarding equipment, the forwarding equipment further modifies the value of the MSS option in the Ack message or the communication message with the MTU value of the local forwarding equipment before forwarding the Ack message or the communication message.

That is to say, after the TCP connection is successfully established, the values of the MSS option in the Ack message and the communication message can be modified so that the communication equipments can timely respond subsequent changes that may occur to the PMTU, and thus, the PMTU learning in hop-by-hop manner resulted from the changing in the MTU value of one or more forwarding equipments after the TCP connection is successfully established can be avoided.

In accordance with the same principles as the above methods, the present disclosure also provides a PMTU learning apparatus can include modules described below. The modules may be hardware only or machine readable instructions executed by a process or other hardware.

A first module is to receive and forward a Syn message sent from an initiator-end communication equipment to a responder-end communication equipment; modify a value of an MSS option in the Syn message with an MTU value of the local PMTU learning apparatus before forwarding if it is determined that the value of the MSS option in the Syn message is greater than the MTU value of the local PMTU learning apparatus. If the Syn message is sent from the initiator-end communication equipment, the value of the MSS option in the Syn message is an MTU value of the initiator-end communication equipment.

A second module is to receive and forward a Syn+Ack message sent from the responder-end communication equipment to the initiator-end communication equipment. When the Syn+Ack message is sent from the responder-end communication equipment, a value of an MSS option in the Syn+Ack message is the value of the MSS option in the Syn message when the Syn message reaches the responder-end communication equipment.

A third module is to receive and forward an Ack message sent from the initiator-end communication equipment to the responder-end communication equipment. When the Ack message is sent from the initiator-end communication equipment, a value of an MSS option in the Ack message is the value of the MSS option in the Syn+Ack message when the Syn+Ack message reaches the initiator-end communication equipment.

Further, if the second module further determines that the value of the MSS option in the Syn+Ack message is greater than the MTU value of the local PMTU learning apparatus, the second module can further modify the value of the MSS option in the Syn+Ack message with the MTU value of the local PMTU learning apparatus before forwarding.

Moreover, in order to improve the security of the PMTU table, when the Syn+Ack message reaches the initiator-end communication equipment, PMTU learning of the initiator-end communication equipment is triggered, thus, the initiator-end communication equipment learns the value of the MSS option in the Syn+Ack message as PMTU and establishes a PMTU table. When the Ack message reaches the responder-end communication equipment, PMTU learning of the responder-end communication equipment is triggered, thus, the responder-end communication equipment learns the value of the MSS option in the Ack message as PMTU and establishes a PMTU table.

In order to adapt to the situation that the MTU value of the forwarding equipment may be changed after the TCP connection is successfully established, if the third module further determines that the value of the MSS option in the Ack message is greater than the MTU value of the local forwarding equipment, the third module can further modify the value of the MSS option in the Ack message with the MTU value of the local forwarding equipment before forwarding.

The PMTU learning apparatus can further include a fourth module which is to receive and forward communication messages interacting between the initiator-end communication equipment and the responder-end communication equipment; modify a value of an MSS option in the communication message with the MTU value of the local PMTU learning apparatus before forwarding if it is determined that the value of the MSS option in the communication message is sent from the initiator-end communication equipment, the value of the MSS option in the communication message is the MTU value of the initiator-end communication equipment; when the communication message is sent from the responder-end communication equipment, the value of the MSS option in the communication message is the MTU learned by the responder-end communication equipment.

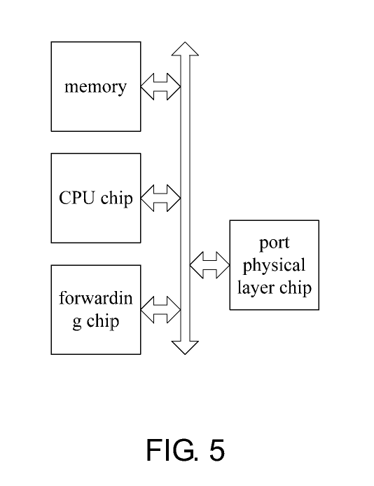

FIG. 5 is a hardware framework diagram of a PMTU learning apparatus according to an example of the present disclosure. As shown in FIG. 5, a hardware framework of a forwarding equipment usually includes a CPU chip connected with a bus, a memory, a forwarding chip and a port physical layer chip.

The CPU chip carries the above apparatus of the present disclosure and is to implement all functions of the apparatus.

The memory is to save a variety of temporary data when the CPU chip processes things. The memory may store machine readable instructions at runtime for PMTU learning modules that may include the modules described above and perform the methods and functions described herein. The machine readable instructions may be executed by the CPU chip.

The forwarding chip is to receive messages through the port physical layer chip, and report messages such as Syn message, Syn+Ack message, Ack message and communication message which need to be processed by the CPU chip to the CPU chip, and forward messages such as Syn message, Syn+Ack message, Ack message and communication message which needs to be directly forwarded through the port physical layer chip.

The port physical layer chip is to drive a port of the forwarding equipment as an ingress port to receive messages, or as an egress port to send messages.

The methods, units and apparatus described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided, which is to store instructions to cause a machine to execute a method as described herein. Specifically, a system or apparatus having a storage medium that stores machine-readable program codes for implementing functions of any of the above examples and that may make the system or the apparatus (or CPU or MPU) read and execute the program codes stored in the storage medium.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and/or other non-transitory computer readable mediums. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize a technical scheme of any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to realize a technical scheme of any of the above examples.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

What is claimed is:

1. A method comprising:
receiving and forwarding, by a forwarding equipment, a first transmission control protocol (TCP) negotiation message sent from a first communication equipment to a second communication equipment;
if it is determined that a value of a maximum segment size (MSS) option in the first TCP negotiation message is greater than a maximum transmission unit (MTU) value of the forwarding equipment, modifying, by the forwarding equipment, the value of the MSS option in the first TCP negotiation message with the MTU value of the forwarding equipment, before forwarding the first TCP negotiation message; and
receiving and forwarding, by the forwarding equipment, a second TCP negotiation message sent from the second communication equipment to the first communication equipment, wherein the second TCP negotiation message is sent from the second communication equipment, and a value of an MSS option in the second TCP negotiation message is the value of the MSS option in the first TCP negotiation message when the first TCP negotiation message reaches the second communication equipment.

2. The method of claim 1, wherein the first TCP negotiation message is a syn message or a syn+ack message, and the second TCP negotiation message is a syn+ack message or an ack message.

3. The method of claim 1, wherein if the value of the MSS option in the second TCP negotiation message is greater than a changed MTU value of the forwarding equipment, then the receiving and forwarding by the forwarding equipment further comprises: modifying, by the forwarding equipment, the value of the MSS option in the second TCP negotiation message with the changed MTU value of the forwarding equipment, before forwarding the second TCP negotiation message.

4. The method of claim 1, wherein when the first TCP negotiation message is a Syn message and the second TCP negotiation message is a Syn+ack message, and when the second TCP negotiation message reaches the first communication equipment, the second TCP negotiation message triggers the first communication equipment to learn the value of the MSS option in the second TCP negotiation message as a path maximum transmission unit (PMTU) and establishes a PMTU table; the method further comprising:
receiving and forwarding, by the forwarding equipment, an Ack message sent from the first communication equipment to the second communication equipment, wherein when the Ack is sent from the first communication equipment, a value of an MSS option in the Ack message is the value of the MSS option in the second TCP negotiation message when the second TCP negotiation message reaches the first communication equipment;
when the Ack message reaches the second communication equipment, the Ack message triggers the second communication equipment to learn the value of the MSS option in the Ack message as PMTU and establish a PMTU table.

5. The method of claim 1, wherein when the first TCP negotiation message is a Syn+ack message and the second TCP negotiation message is an Ack message, and when the first TCP negotiation message reaches the second communication equipment, the first TCP negotiation message triggers the second communication equipment to learn the value of the MSS option in the first TCP negotiation message as a PMTU and establishes a PMTU table, and when the second TCP negotiation message reaches the first communication equipment, the second TCP negotiation message triggers the first communication equipment to learn the value of the MSS option in the second TCP negotiation message as a PMTU and establishes a PMTU table.

6. The method of claim 1, further comprising:
receiving and forwarding, by the forwarding equipment, a communication message interacting between the first communication equipment and the second communication equipment;
if it is determined that a value of an MSS option in the communication message is greater than the MTU value of the forwarding equipment, modifying, by the forwarding equipment, the value of the MSS option in the communication message with the MTU value of the forwarding equipment, before forwarding the communication message; wherein when the value of the MSS option in the communication message is PMTU learned by the communication equipment which sends the communication message.

7. An apparatus comprising:
at least one network interface to receive and send a TCP negotiation message; and
a processor to, when it is determined that a value of a maximum segment size (MSS) option in the TCP negotiation message is greater than a maximum transmission unit (MTU) value of the apparatus, modify the value of the MSS option in the TCP negotiation message with the MTU value of the apparatus before forwarding, wherein when the TCP negotiation message is sent from a source end communication equipment, the value of the MSS option in the TCP negotiation message is an MTU value of the source end communication equipment.

8. The apparatus of claim 7, wherein the processor is to:
receive and forward a Syn message sent from the source end communication equipment to a destination end communication equipment,
modify a value of an MSS option in the Syn message with the MTU value of the apparatus before forwarding if it is determined that the value of the MSS option in the Syn message is greater than the MTU value of the apparatus, wherein when the Syn message is sent from the source end communication equipment, the value of the MSS option in the Syn message is the MTU value of the source end communication equipment,
receive and forward a Syn+Ack message sent from the destination end communication equipment to the source end communication equipment, wherein when the Syn+Ack message is sent from the destination end communication equipment, a value of an MSS option in the Syn+Ack message is the value of the MSS option in the Syn message when the Syn message reaches the destination end communication equipment,
receive and forward an Ack message sent from the source end communication equipment to the destination end communication equipment, and when the Ack message is sent from the source end communication equipment, a value of an MSS option in the Ack message is the value of the MSS option in the Syn+Ack message when the Syn+Ack message reaches the source end communication equipment.

9. The apparatus of claim 8, wherein if the processor determines that the value of the MSS option in the Syn+Ack message is greater than a changed MTU value of the apparatus, the processor is to modify the value of the MSS option in the Syn+Ack message with the changed MTU value of the apparatus before forwarding.

10. The apparatus of claim 7, wherein when the Syn+Ack message reaches the source end communication equipment, the Syn+Ack message triggers the source end communication equipment to learn the value of the MSS option in the Syn+Ack message as PMTU and establish a PMTU table, and when the Ack message reaches the destination end communication equipment, the Ack message triggers the destination end communication equipment to learn the value of the MSS option in the Ack message as PMTU and establish a PMTU table.

11. The apparatus of claim 8, wherein if the processor determines that the value of the MSS option in the Ack message is greater than a changed MTU value of the PMTU learning apparatus, the processor is to modify the value of the MSS option in the Ack message with the changed MTU value of the apparatus before forwarding.

12. The apparatus of claim 8, wherein the processor is to:
receive and forward a communication message between the source end communication equipment and the destination end communication equipment, and
modify a value of an MSS option in the communication message with the MTU value of the apparatus before forwarding if it is determined that the value of the MSS option in the communication message is greater than the MTU value of the apparatus, wherein the value of the MSS option in the communication message is a PMTU learned by the communication equipment which sends the communication message.

13. A forwarding equipment comprising:
a processor to:
receive and forward a TCP negotiation message sent from a source end communication equipment to a destination end communication equipment, and
if it is determined that a value of a maximum segment size (MSS) option in the TCP negotiation message is greater than a maximum transmission unit (MTU) value of the forwarding equipment, modify the value of the MSS option in the TCP negotiation message with the MTU value of the forwarding equipment, before forwarding the TCP negotiation message, wherein when the TCP negotiation message is sent from the source end communication equipment, the value of the MSS option in the TCP negotiation message is the MTU value of the source end communication equipment; and
a memory to save the MTU value of the forwarding equipment.
